(19) United States
(12) Patent Application Publication
(10) Pub. No.: US 2024/0270300 A1
(43) Pub. Date: Aug. 15, 2024

(54) CART MOVEMENT ASSIST DEVICE

(71) Applicant: AISIN CORPORATION, Kariya (JP)

(72) Inventors: Yuta ZENJI, Kariya-shi (JP); Kuniyuki Hashimoto, Kariya-shi (JP); Tadayoshi Funahara, Kariya-shi (JP)

(73) Assignee: AISIN CORPORATION, Kariya (JP)

(21) Appl. No.: 18/422,733

(22) Filed: Jan. 25, 2024

(30) Foreign Application Priority Data
Feb. 10, 2023 (JP) 2023-019441

(51) Int. Cl. B62B 5/00

(52) U.S. Cl. CPC B62B 5/0066; B62B 2301/00

(57) ABSTRACT

A cart movement assist device, which is attached to a rear end portion side of a cart which is a side where a worker is located, and which assists a movement of the cart, includes: an assist tire; a backward movement pedal that is pivotably operated; and a backward movement torque transmission mechanism configured to generate an assist force for moving the cart backward, by transmitting a torque generated by an operation on the backward movement pedal to the assist tire and rotating the assist tire.

### CROSS REFERENCE TO RELATED APPLICATIONS

This application is based on and claims priority under 35 U.S.C. § 119 to Japanese Patent Application 2023-019441, filed on Feb. 10, 2023, the entire content of which is incorporated herein by reference.

### TECHNICAL FIELD

This disclosure relates to a cart movement assist device.

### BACKGROUND DISCUSSION

In the related art, a cart whose movement can be assisted is known (for example, see JP 2009-196437A (Reference 1)).

Reference 1 discloses a hand cart including a foot pedal that is pivotably operated, an auxiliary wheel, and a transmission mechanism that transmits a torque generated by the pivotable operation of the foot pedal to the auxiliary wheel. The transmission mechanism includes a sprocket disposed adjacent to the auxiliary wheel and rotating together with the auxiliary wheel, and a chain wound around the sprocket. The chain is connected to the foot pedal, and the foot pedal is operated by a worker to rotate the sprocket. As a result, the auxiliary wheel rotates in a predetermined direction together with the sprocket, and the hand cart starts to move forward, which is a side opposite to a side where the worker is located, with respect to the hand cart.

In the related art, there has been an assist device that can assist a forward movement of the cart like the hand cart described in Reference 1, but there is a demand to assist a backward movement of the cart instead of assisting the forward movement of the cart.

A need thus exists for a cart movement assist device which is not susceptible to the drawback mentioned above.

### SUMMARY

According to an aspect of this disclosure, a cart movement assist device, which is attached to a rear end portion side of a cart which is a side where a worker is located, and which assists a movement of the cart, includes: an assist tire; a backward movement pedal that is pivotably operated; and a backward movement torque transmission mechanism configured to generate an assist force for moving the cart backward, by transmitting a torque generated by an operation on the backward movement pedal to the assist tire and rotating the assist tire.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view showing a use state of a cart movement assist device according to a first embodiment;

FIG. 2 is a perspective view of the cart movement assist device according to the first embodiment;

FIG. 3 is a side view of the cart movement assist device according to the first embodiment;

FIG. 4 is a plan view of the cart movement assist device according to the first embodiment;

FIG. 5 is a cross-sectional view of the cart movement assist device taken along a line V-V in FIG. 4;

FIG. 6 is a cross-sectional view of the cart movement assist device taken along a line VI-VI in FIG. 4;

FIG. 7 is a view of a backward movement mechanism as viewed from an A1 direction indicated by the arrow in FIG. 4;

FIG. 8 is a view of a forward movement mechanism as viewed from an A2 direction indicated by the arrow in FIG. 4;

FIG. 9 is a diagram illustrating an operation of the backward movement mechanism of the cart movement assist device according to the first embodiment;

FIG. 10 is a side view of a cart movement assist device according to a second embodiment;

FIG. 11 is a plan view of a cart movement assist device according to a modification;

FIG. 12 is a cross-sectional view of the cart movement assist device taken along a line XII-XII in FIG. 11; and

FIG. 13 is a view of an annular chain, a third sprocket, and a fourth sprocket of the backward movement mechanism as viewed from an A3 direction indicated by the arrow in FIG. 11.

### DETAILED DESCRIPTION

Hereinafter, embodiments will be described with reference to the drawings.

### First Embodiment

### Schematic Configuration of Cart Movement Assist Device

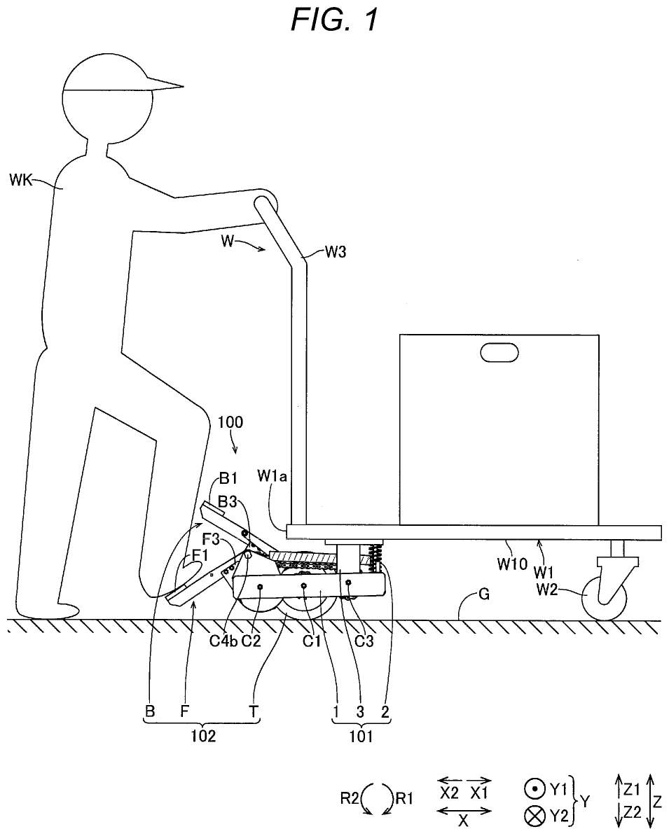

A configuration of a cart movement assist device 100 according to an embodiment will be described with reference to FIGS. 1 to 9.

The cart movement assist device 100 shown in FIGS. 1 to 4 is a device that is attached to a cart W and assists a forward movement of the cart W and a backward movement of the cart W. In short, the cart movement assist device 100 is a device for reducing a burden (work) on a worker WK to push the cart W in a front-rear direction.

Here, in each of the drawings, an up-down direction is shown as a Z direction. In the Z direction, the upper side is indicated by a Z1 direction, and the lower side is indicated by a Z2 direction.

In each of the drawings, the front-rear direction of the cart W is indicated by an X direction. In the X direction, the front of the cart W is indicated by an X1 direction, and the rear thereof is indicated by an X2 direction. The rear (X2 direction) is a direction facing a side where the worker WK who operates the cart W is located from the cart W side.

In each of the drawings, a left-right (width) direction of the cart W is indicated as a Y direction. In the Y direction, the right side with respect to the worker WK is indicated by a Y1 direction, and the left side is indicated by a Y2 direction. The Y direction is a direction perpendicular to the Z direction and the X direction. In each of the drawings, a center position of the cart movement assist device 100 in the left-right direction is indicated by a center line α. An assist tire T is disposed on the center line α.

In each of the drawings, a rotation direction of the assist tire T when the cart W is moved forward by the cart movement assist device 100 is indicated by an R1 direction. The rotation direction of the assist tire T when the cart W is moved backward by the cart movement assist device 100 is indicated by an R2 direction. The assist tire T rotates in the R1 and R2 directions about a central axis C1 extending in the left-right direction (Y direction).

The R1 direction is a clockwise direction when the cart movement assist device 100 is viewed from the right side. The R2 direction is a counterclockwise direction when the cart movement assist device 100 is viewed from the right side. In the present description, the clockwise direction (counterclockwise direction) when the cart movement assist device 100 is viewed from the right side (left side) will be described as the R1 direction. Further, the counterclockwise direction (clockwise direction) when the cart movement assist device 100 is viewed from the right side (left side) will be described as the R2 direction.

Similarly to the assist tire T, an output-side chain guide B21 of a backward movement mechanism B, which will be described later, rotates in the R2 direction about the central axis C1 during the backward movement. An input-side chain guide B20 of the backward movement mechanism B rotates in the R2 direction about a central axis C2 during the backward movement.

Similarly to the assist tire T, an output-side chain guide F21 of a forward movement mechanism F, which will be described later, rotates in the R1 direction about the central axis C1 during the forward movement. An input-side chain guide F20 of the forward movement mechanism F rotates in the R2 direction about the central axis C2 during the forward movement. An auxiliary chain guide F23 of the forward movement mechanism F rotates in the R2 direction about a central axis C3 during the forward movement.

The central axes C1, C2, and C3 are axes extending in the left-right direction (Y direction) and parallel to one another. The central axis C3 is located in front of the central axis C1, and the central axis C2 is located behind the central axis C1. The central axis C3 is also a pivot center of a support member 1 extending in the front-rear direction of an attachment mechanism 101 described later. The central axes C1, C2, and C3 are axes located at centers of central shaft members C10, C20, and C30 extending in the left-right direction, respectively.

As a result of an operation performed by the worker WK, a backward movement pedal B1 rotates in the R2 direction about a central axis C4a. Then, as a result of a further operation performed by the worker WK, the backward movement pedal B1 (central axis C4a) moves in the R2 direction about the central axis C2. The central axis C4a is an axis located at a center of a pivot fulcrum portion B12 extending in the left-right direction.

As a result of an operation performed by the worker WK, the forward movement pedal F1 rotates in the R2 direction about a central axis C4b. As a result of the operation performed by the worker WK, the forward movement pedal F1 (central axis C4b) moves in the R2 direction about the central axis C2. The central axis C4b is an axis located at a center of a pivot fulcrum portion F12 extending in the left-right direction.

The cart movement assist device 100 is attached to a rear end portion W1a side of the cart W, which is a side where the worker WK is located, and assists the movement of the cart W. Specifically, the cart movement assist device 100 is attached to a lower surface W10 of a loading platform W1 of the cart W on the rear end portion side of the cart W where the worker WK is located.

The cart movement assist device 100 is configured such that, when the worker WK steps on the backward movement pedal B1 of the stopped cart W to perform a stepping-on operation of pivoting the backward movement pedal B1 downward, a torque generated by the stepping-on operation is transmitted to the assist tire T to rotate the assist tire T in the R2 direction. As a result, the stopped cart W starts to move backward.

In addition, the cart movement assist device 100 is configured such that, when the worker WK steps on the forward movement pedal F1 of the stopped cart W to perform a stepping-on operation of pivoting the forward movement pedal F1 downward, a torque generated by the stepping-on operation is transmitted to the assist tire T to rotate the assist tire T in the R1 direction. As a result, the stopped cart W starts to move forward.

The torque of the assist tire T is generated only in the period during which the stepping-on operations on the backward movement pedal B1 and the forward movement pedal F1 are performed. As described above, the stepping-on operations on the backward movement pedal B1 and the forward movement pedal F1 are mainly performed on the stopped cart W. That is, the cart movement assist device 100 is a device for assisting an initial movement when the cart W is moved forward and backward.

### Configuration of Cart

Before describing a detailed configuration of the cart movement assist device 100, an example of a configuration of the cart W to which the cart movement assist device 100 is attached will be described.

The cart W includes the rectangular loading platform W1 extending in a horizontal direction, a plurality of wheels W2 disposed at four corners of the loading platform W1, and a handle W3 held by the worker WK.

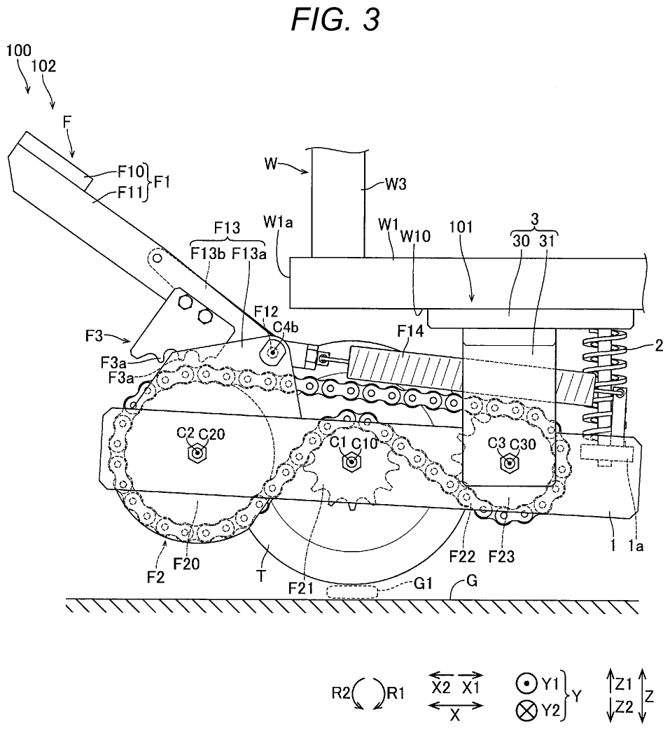

The plurality of wheels W2 of the cart W are normally held in a state of being in contact with the ground G except a case in which the cart W travels on the uneven ground G. On the other hand, the assist tire T of the cart movement assist device 100 is held in a state (floating state) in which the assist tire T is separated upward from the ground G by a predetermined gap G1 (see FIG. 3) except a period in which the stepping-on operation is performed. The plurality of wheels W2 of the cart W change directions thereof in accordance a movement direction of the cart W. On the other hand, the assist tire T of the cart movement assist device 100 maintains a direction for moving in the front-rear direction determined by the central axis C1 extending in the left-right direction.

### Detailed Configuration of Cart Movement Assist Device

The cart movement assist device 100 includes the attachment mechanism 101 for attaching the cart movement assist device 100 to the cart W, and a movement mechanism 102 driven to move the cart W.

The attachment mechanism 101 includes the support members 1, compression biasing bodies 2, and attachment members 3. The support members 1 support the movement mechanism 102. The compression biasing body 2 has a function of biasing the support member 1 and holding the assist tire T in a state of being separated upward from the ground G. The attachment member 3 is a member for attaching the support member 1 to the lower surface W10 of the loading platform W1 of the cart W.

The movement mechanism 102 includes the assist tire T, the backward movement mechanism B that rotates the assist tire T in the R2 direction, and the forward movement mechanism F that rotates the assist tire T in the R1 direction.

Hereinafter, the components of the attachment mechanism 101 and the movement mechanism 102 will be described in detail in order.

### Configuration of Support Member of Attachment Mechanism

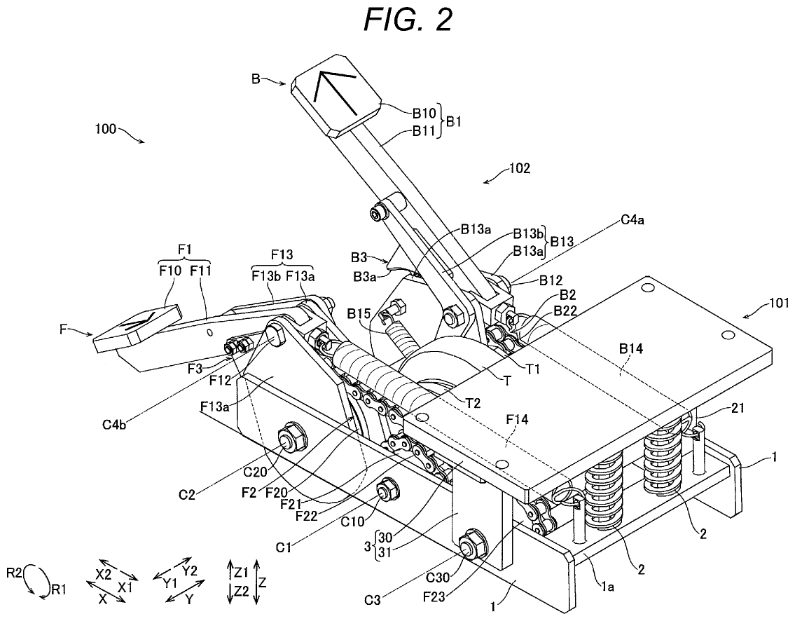

As shown in FIG. 2, the support member 1 is a rectangular plate member for which the front-rear direction corresponds to a longitudinal direction of the rectangular plate member, the up-down direction corresponds to a short direction, and the left-right direction corresponds to a thickness direction. A pair of support members 1 are provided in a manner of being separated from each other in the left-right direction. Between the support member 1 on the right side (Y1 direction side) and the support member 1 on the left side (Y2 direction side), the forward movement mechanism F, the assist tire T, and the backward movement mechanism B are disposed in this order from the right side to the left side. The pair of support members 1 support the forward movement mechanism F, the assist tire T, and the backward movement mechanism B in a state of sandwiching them from both sides in the left-right direction. The support member 1 is supported by the attachment member 3 in front of the assist tire T. The support member 1 is supported by the attachment member 3 in a state of being pivotable about the central axis C3.

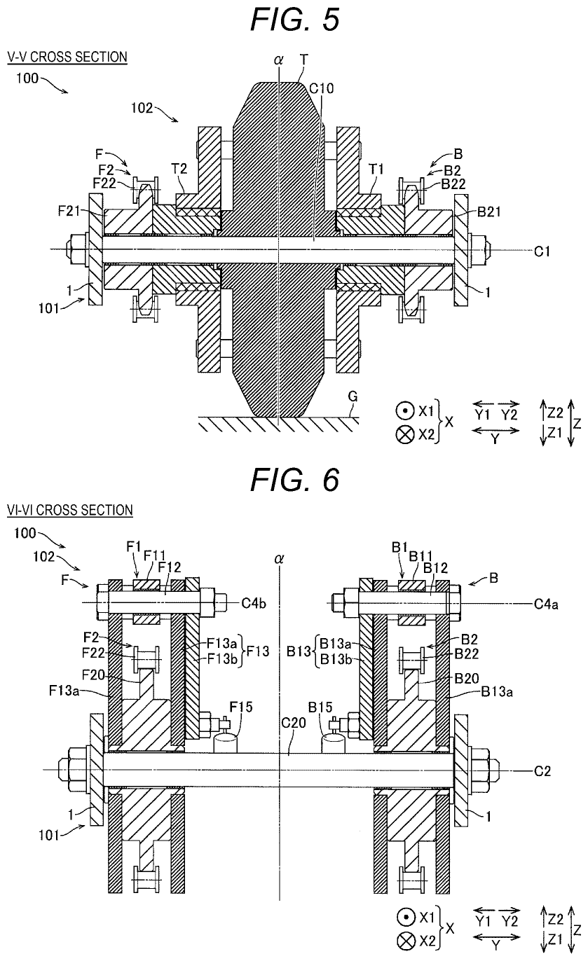

The support member 1 supports the assist tire T, the output-side chain guide B21 of the backward movement mechanism B, and the output-side chain guide F21 of the forward movement mechanism F via the central shaft member C10 in a state of being rotatable about the central axis C1 (see FIG. 5). Further, the support member 1 supports the input-side chain guide B20 of the backward movement mechanism B and the input-side chain guide F20 of the forward movement mechanism F via the central shaft member C20 in a state of being rotatable about the central axis C2 (see FIG. 6).

A biased portion 1a is integrally provided on front end portions of the pair of support members 1. The biased portion 1a is a plate part extending in the left-right direction and connects the pair of support members 1. The compression biasing bodies 2 abut against the biased portion 1a from above. The biased portion 1a is biased downward by the compression biasing bodies 2. That is, the front end portions of the pair of support members 1 are biased downward by the compression biasing bodies 2.

### Configuration of Compression Biasing Body of Attachment Mechanism

The compression biasing body 2 is disposed in a compressed state between a lower surface of a first attachment portion 30 (described later) of the attachment member 3 and an upper surface of the biased portion 1a. A plurality of compression biasing bodies 2 are provided side by side in the left-right direction. As an example, the compression biasing body 2 is formed of an elastic member such as a compression coil spring.

As described above, the compression biasing body 2 biases the pair of support members 1 downward in front of the central shaft member C30. The pair of support members 1 are supported by the central shaft member C30 in a pivotable state. That is, the compression biasing body 2 applies a torque in the R1 direction about the central axis C3 to the support members 1.

As a result, behind the central shaft member C30, the assist tire T supported by the support member 1 is biased upward, and the assist tire T is held in a state of being separated from the ground G by the predetermined gap G1 (see FIG. 3). Therefore, after the cart W starts to move, the assist tire T does not receive an excessive load from the ground G when traveling in an oblique direction inclined with respect to the front-rear direction in a plan view, not in the front-rear direction.

When the stepping-on operation of pivoting the forward movement pedal F1 and the backward movement pedal B1 downward is performed, the support member 1 receives a torque in the R2 direction against the biasing force of the compression biasing body 2, and thus the assist tire T is held in a state of being in contact with the ground G.

### Configuration of Attachment Member of Attachment Mechanism

The attachment member 3 includes the first attachment portion 30 directly fixed to the lower surface W10 (see FIG. 3) of the loading platform W1 of the cart W, and a pair of second attachment portions 31 each disposed between the first attachment portion 30 and the support member 1.

The first attachment portion 30 has a rectangular shape extending along the lower surface W10 of the loading platform W1. As an example, the first attachment portion 30 is fixed to the lower surface W10 of the loading platform W1 by a fixing member such as a bolt (not shown). The first attachment portion may be fixed to the lower surface of the loading platform by other methods such as welding.

The second attachment portion 31 has an elongated shape extending downward from a first attachment portion 30 side. A pair of second attachment portions 31 are provided in a manner of being separated from each other in the left-right direction. An upper portion of the second attachment portion 31 is fixed to the first attachment portion 30, and a lower portion of the second attachment portion 31 supports the support member 1 in a pivotable state via the central shaft member C30. The second attachment portion 31 supports the auxiliary chain guide F23 of the forward movement mechanism F in a pivotable state via the central shaft member C30.

The assist tire T, the backward movement pedal B1, and the forward movement pedal F1 are disposed behind the second attachment portions 31. The biased portion 1a and the compression biasing bodies 2 are disposed in front of the second attachment portions 31.

### Configuration of Assist Tire of Movement Mechanism

Among the components of the cart movement assist device 100, only the assist tire T comes into contact with the ground G. The assist tire T comes into contact with the ground G only when the stepping-on operation of pivoting the forward movement pedal F1 and the backward movement pedal B1 downward is performed, except when the assist tire T travels on the uneven ground G.

The cart W moves forward when the assist tire T in contact with the ground G rotates in the R1 direction about the central axis C1, and moves backward when the assist tire T rotates in the R2 direction. In the left-right direction, the assist tire T is disposed between the backward movement mechanism B located on the left of the assist tire T and the forward movement mechanism F located on the right of the assist tire T.

### Configuration of Backward-Movement One-Way Clutch and Forward-Movement One-Way Clutch

As shown in FIGS. 2 and 5, the assist tire T is provided with a backward-movement one-way clutch T1 and a forward-movement one-way clutch T2.

The backward-movement one-way clutch T1 is disposed between the assist tire T and the backward movement mechanism B. The backward-movement one-way clutch T1 connects the output-side chain guide B21 and the assist tire T so that, when a torque that causes the output-side chain guide B21 to rotate in the R2 direction is generated in the backward movement mechanism B, the torque is transmitted to the assist tire T.

The backward-movement one-way clutch T1 disconnects the output-side chain guide B21 and the assist tire T so that, when a torque that causes the output-side chain guide B21 to rotate in the R1 direction is generated in the backward movement mechanism B, the torque is not transmitted to the assist tire T.

The forward-movement one-way clutch T2 is disposed between the assist tire T and the forward movement mechanism F. The forward-movement one-way clutch T2 connects the output-side chain guide F21 and the assist tire T so that, when a torque that causes the output-side chain guide F21 to rotate in the R1 direction is generated in the forward movement mechanism F, the torque is transmitted to the assist tire T.

The forward-movement one-way clutch T2 disconnects the output-side chain guide F21 and the assist tire T so that, when a torque that causes the output-side chain guide F21 to rotate in the R2 direction is generated in the forward movement mechanism F, the torque is not transmitted to the assist tire T.

Accordingly, when the assist tire T is rotated in the R1 direction (moved forward) by the forward movement mechanism F, the torque is transmitted from the assist tire T to the backward movement mechanism B via the backward-movement one-way clutch T1, and a chain B22 of the backward movement mechanism B is also rotated. In this case, the connection between the chain B22 of the backward movement mechanism B and the backward movement pedal B1 is held in a disconnected state by a claw member B3 of the backward movement mechanism B, and thus the backward movement pedal B1 does not move. Details of the claw member B3 of the backward movement mechanism B will be described later. The claw member B3 of the backward movement mechanism B is an example of a “connection switching member” in the claims.

When the assist tire T is rotated in the R2 direction (moved backward) by the backward movement mechanism B, the torque is transmitted from the assist tire T to the forward movement mechanism F via the forward-movement one-way clutch T2, and a chain F22 of the forward movement mechanism F is also rotated. In this case, the connection between the chain F22 of the forward movement mechanism F and the forward movement pedal F1 is held in a disconnected state by a claw member F3 of the forward movement mechanism F, and thus the forward movement pedal F1 does not move. Details of the claw member F3 of the forward movement mechanism F will be described later.

### Configuration of Backward Movement Mechanism of Movement Mechanism

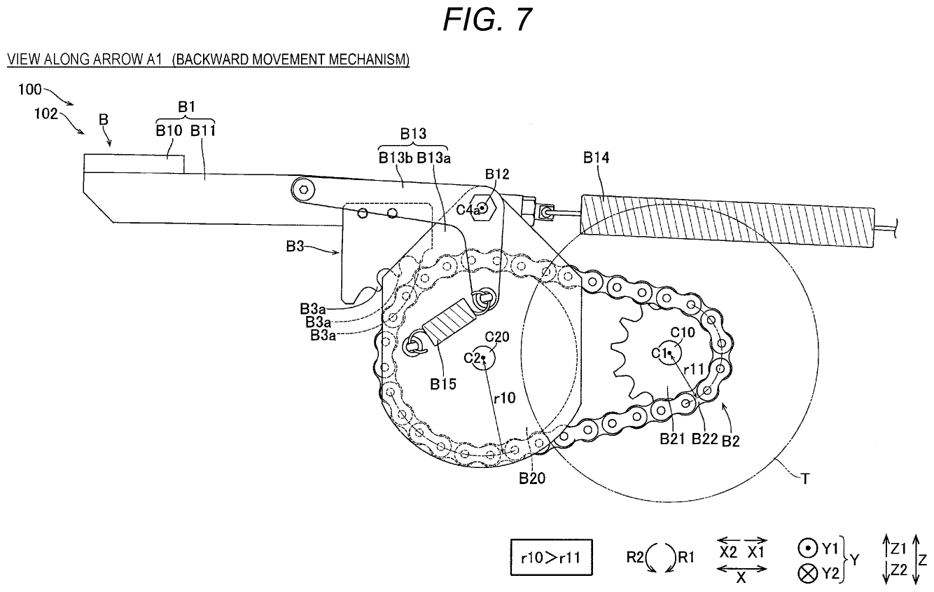

As shown in FIG. 7, the backward movement mechanism B includes the backward movement pedal B1, a backward movement torque transmission mechanism B2, and the claw member B3 provided on the backward movement pedal B1.

The backward movement mechanism B rotates the assist tire T in the R2 direction by transmitting a torque generated by a stepping-on operation on the backward movement pedal B1 performed by the worker WK (see FIG. 1) to the assist tire T via the backward movement torque transmission mechanism B2. The claw member B3 switches between a connection state and a disconnection state of the backward movement pedal B1 and the backward movement torque transmission mechanism B2.

### Configuration of Backward Movement Pedal Provided in Backward Movement Mechanism of Movement Mechanism

The backward movement pedal B1 includes a pedal portion B10 that is operated by being stepped on by a lower limb of the worker WK, and a beam portion B11 having a rear end to which the pedal portion B10 is fixed.

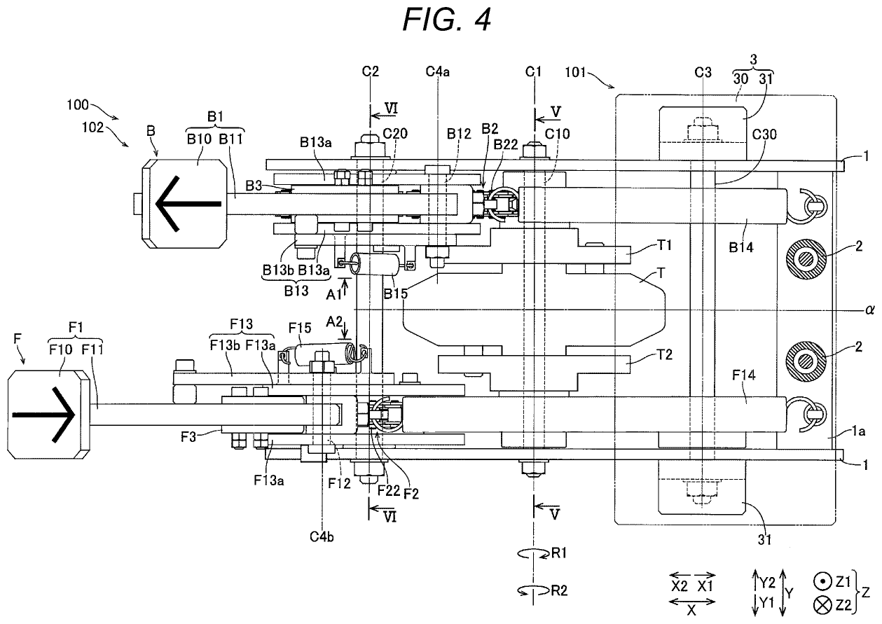

A picture of an arrow directed rearward (see FIG. 4), which indicates a direction of moving the cart W (see FIG. 1) by the backward movement mechanism B, is drawn on an upper surface of the pedal portion B10. The claw member B3 is fixed to the beam portion B11. The claw member B3 protrudes downward from a lower surface of the beam portion B11 toward the chain B22.

The backward movement pedal B1 is provided with a pivot fulcrum portion B12, a movement support member B13, a first tension biasing body B14, and a second tension biasing body B15.

The first tension biasing body B14 has a function of moving the backward movement pedal B1 and the claw member B3 in the R1 direction (forward) around the central axis C2. The second tension biasing body B15 has a function of pivoting the claw member B3 in the R1 direction around the central axis C4a in order to release the engagement between the claw member B3 provided on the backward movement pedal B1 and the chain B22.

The pivot fulcrum portion B12 is disposed in a vicinity of a front end portion of the backward movement pedal B1, which is opposite to the pedal portion B10. The pivot fulcrum portion B12 serves as a pivot fulcrum (central axis C4a) of the backward movement pedal B1 and pivots the claw member B3 together with the backward movement pedal B1, so that the claw member B3 engages with a part of the chain B22 wound around the input-side chain guide B20. In short, the pivot fulcrum portion B12 is a shaft portion that pivotably supports the backward movement pedal B1.

The movement support member B13 includes first members B13a that support the backward movement pedal B1 via the pivot fulcrum portion B12, and an L-shaped second member B13b.

A pair of first members B13a are provided on both sides of the backward movement pedal B1 in the left-right direction. The first members B13a move the claw member B3 in a state of being engaged with the chain B22 by the pivot fulcrum portion B12 along a circumferential direction of the input-side chain guide B20. The first members B13a are supported by the support member 1 of the attachment mechanism 101 in a state of being rotatable around the central axis C2. That is, the backward movement pedal B1 is supported by the support member 1 via the first members B13a. Accordingly, the backward movement pedal B1 and the pivot fulcrum portion B12 are movable around the central axis C2 by the movement support member B13.

The rear end portion of the first tension biasing body B14 is attached to the pivot fulcrum portion B12, and a front end portion thereof is attached to the biased portion 1a. As an example, the first tension biasing body B14 is formed of an elastic member such as a tension coil spring. The first members B13a and the backward movement pedal B1 are constantly biased (pulled) forward by the first tension biasing body B14 via the pivot fulcrum portion B12. That is, the first members B13a, the backward movement pedal B1, and the claw member B3 constantly receive a torque in the R1 direction about the central axis C2 from the first tension biasing body B14.

One end of the L-shaped second member B13b is fixed to a vicinity of a center of the backward movement pedal B1 in the longitudinal direction, and the other end thereof is attached to a side surface of the first member B13a via the second tension biasing body B15. As an example, the second tension biasing body B15 is formed of an elastic member such as a tension coil spring.

The L-shaped second member B13b is supported by the pivot fulcrum portion B12 in a state of being pivotable about the central axis C4a. The L-shaped second member B13b constantly receives a torque in the R1 direction about the central axis C4a from the second tension biasing body B15. That is, the L-shaped second member B13b constantly receives a torque from the second tension biasing body B15 in a direction in which the engagement between the claw member B3 and the chain B22 is released.

In short, the first tension biasing body B14, the second tension biasing body B15, and the L-shaped second member B13b cause the backward movement pedal B1 to return to a predetermined initial position where the engagement between the chain B22 and the claw member B3 is released when the stepping-on operation is released from the state during the stepping-on operation in which the chain B22 and the claw member B3 are engaged.

### Configuration of Backward Movement Torque Transmission Mechanism Provided in Backward Movement Mechanism of Movement Mechanism

The backward movement torque transmission mechanism B2 shown in FIG. 7 generates an assist force for moving the cart W (see FIG. 1) backward, by transmitting the torque generated by an operation on the backward movement pedal B1 to the assist tire T and rotating the assist tire T.

The backward movement torque transmission mechanism B2 includes the input-side chain guide B20, the output-side chain guide B21, and the annular chain B22. As an example, the input-side chain guide B20 is implemented by a circular guide member that guides the wound chain B22 by sliding. The input-side chain guide B20 is disposed between the pair of first members B13a and fixed to the first members B13a. As an example, the output-side chain guide B21 is implemented by a circular sprocket that guides the wound chain B22.

The input-side chain guide B20 is disposed behind the output-side chain guide B21 and below the backward movement pedal B1. The input-side chain guide B20 is disposed immediately below the claw member B3 in a manner of being separated from the claw member B3 in a state in which the stepping-on operation on the backward movement pedal B1 is not performed. The input-side chain guide B20 is formed in a circular shape centered on the central axis C2 when viewed in the left-right direction.

The chain B22 is wound around the input-side chain guide B20 and the output-side chain guide B21. When viewed in the left-right direction, the input-side chain guide B20 and the output-side chain guide B21 are disposed inside the annular chain B22. The chain B22 rotates the input-side chain guide B20 and the output-side chain guide B21 in the same direction.

The output-side chain guide B21 is provided on the assist tire T and outputs a torque to the assist tire T. Specifically, the output-side chain guide B21 is disposed adjacent to a left side of the assist tire T. The output-side chain guide B21 is supported by the central shaft member C10 in a state of being rotatable around the central axis C1. That is, the output-side chain guide B21 rotates around the same central axis C1 as the assist tire T. The backward-movement one-way clutch T1 is disposed between the output-side chain guide B21 and the assist tire T.

A radius r10 of a pitch circle of the input-side chain guide B20 is larger than a radius r11 of a pitch circle of the output-side chain guide B21. That is, a distance from the central axis C2, which is a rotation center of the input-side chain guide B20, to the chain B22 part that engages with the input-side chain guide B20 is larger than a distance from the central axis C1, which is a rotation center of the output-side chain guide B21, to the chain B22 part that engages with the output-side chain guide B21. As an example, a ratio of the radius r10 of the pitch circle of the input-side chain guide B20 to the radius r11 of the pitch circle of the output-side chain guide B21 is 121.5:53.07.

Accordingly, the backward movement torque transmission mechanism B2 increases a rotation amount of the assist tire T with respect to a rotation amount of the backward movement pedal B1 during operation and accelerates the rotation of the assist tire T with respect to the rotation of the backward movement pedal B1 by reducing, by the input-side chain guide B20 and the output-side chain guide B21, the torque received from the backward movement pedal B1 and outputting the reduced torque from the assist tire T.

That is, the backward movement torque transmission mechanism B2 rotates the assist tire T by converting a small rotation amount (rotation speed) input to the input-side chain guide B20 into a large rotation amount (rotation speed) instead of converting a large torque received from the backward movement pedal B1 on the input-side chain guide B20 side into a small torque to rotate the assist tire T. In short, the backward movement torque transmission mechanism B2 can obtain a larger rotation amount (rotation speed) of the assist tire T as an output at the expense of the input torque.

### Configuration of Claw Member Provided in Backward Movement Mechanism of Movement Mechanism

The claw member B3 is fixed to the backward movement pedal B1. Accordingly, the claw member B3 rotates around the central axis C4a together with the backward movement pedal B1.

The claw member B3 has a plurality of protruding portions B3a. The plurality of protruding portions B3a are disposed on the lower side which is the chain B22 side, and engage with the chain B22 part wound around the input-side chain guide B20. The plurality of protruding portions B3a are generally arranged in an arc shape in a manner of being disposed along the chain B22 when the claw member B3 pivots around the central axis C4a and engages with the chain B22.

The claw member B3 connects the backward movement pedal B1 and the chain B22 so that a torque can be transmitted.

Specifically, when the stepping-on operation on the backward movement pedal B1 is performed, the claw member B3 engages with the chain B22 to connect the backward movement pedal B1 and the backward movement torque transmission mechanism B2 so that a torque can be transmitted. On the other hand, when the stepping-on operation on the backward movement pedal B1 is not performed, the claw member B3 releases the engagement with the chain B22 to release the connection between the backward movement pedal B1 and the backward movement torque transmission mechanism B2.

Therefore, even when the stepping-on operation on the forward movement pedal F1 is performed to rotate the chain B22 of the backward movement mechanism B, the claw member B3 of the backward movement mechanism B is not engaged with the chain B22, so that the backward movement pedal B1 is not moved. In short, the claw member B3 cuts off the transmission of the torque from the forward movement pedal F1 subjected to the stepping-on operation to the backward movement pedal B1.

Here, as described above, the backward movement pedal B1 and the pivot fulcrum portion B12 are movable around the central axis C2 by the movement support member B13. Therefore, the claw member B3 rotates the chain B22 by moving together with the chain B22 in the R2 direction around the central axis C2 in a state of being engaged with the chain B22.

In this way, the backward movement mechanism B moves the claw member B3 along the chain B22 in a state in which the claw member B3 is engaged with the chain B22. Therefore, the backward movement mechanism B can maintain the engagement state between the claw member B3 and the chain B22 for a relatively long period of time when the stepping-on operation on the backward movement pedal B1 is performed.

### Configuration of Forward Movement Mechanism of Movement Mechanism

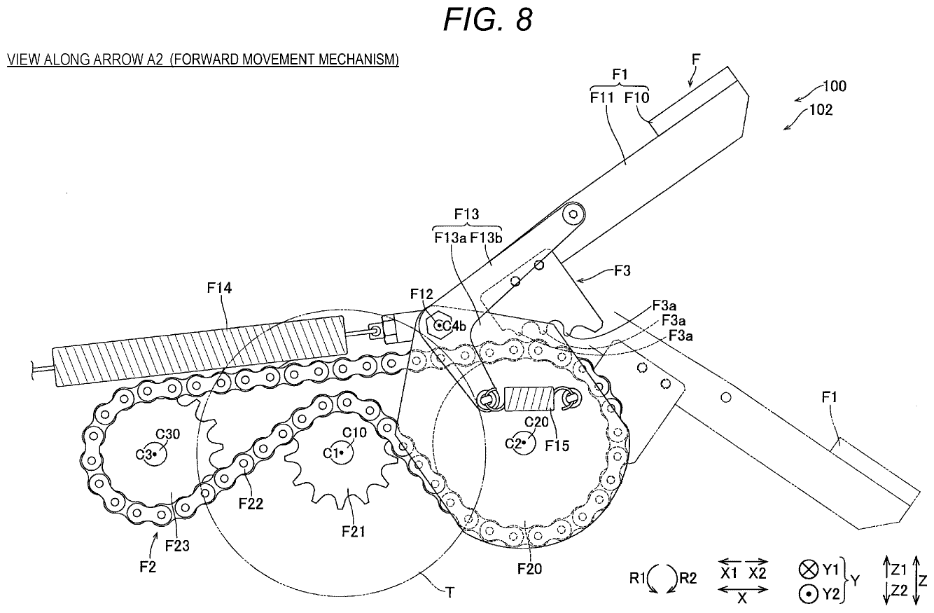

As shown in FIG. 8, the forward movement mechanism F includes the forward movement pedal F1, a forward movement torque transmission mechanism F2, and the claw member F3 provided on the forward movement pedal F1. The claw member F3 has a plurality of protruding portions F3a.

The forward movement mechanism F has the same configuration as the backward movement mechanism B except that the forward movement torque transmission mechanism F2 includes the auxiliary chain guide F23 for changing a rotation direction of the output-side chain guide F21 in addition to the input-side chain guide F20, the output-side chain guide F21, and the chain F22. Therefore, the configurations of the forward movement mechanism F will be briefly described below, and a configuration related to the auxiliary chain guide F23 will be described in detail. As an example, the auxiliary chain guide F23 is implemented by a circular sprocket that guides the wound chain F22.

The forward movement mechanism F rotates the assist tire T in the R1 direction by transmitting a torque generated by a stepping-on operation on the forward movement pedal F1 performed by the worker WK to the assist tire T via the forward movement torque transmission mechanism F2.

The forward movement pedal F1 includes a pedal portion F10 that is operated by being stepped on by a lower limb of the worker WK, and a beam portion F11 having a rear end to which the pedal portion F10 is fixed.

A picture of an arrow directed forward (see FIG. 4), which indicates a direction of moving the cart W by the forward movement mechanism F, is drawn on an upper surface of the pedal portion F10. The claw member F3 is fixed to the beam portion F11. The claw member F3 protrudes downward from a lower surface of the beam portion F11 toward the chain F22.

Similarly to the backward movement pedal B1, the forward movement pedal F1 is provided with the pivot fulcrum portion F12, a movement support member F13, a first tension biasing body F14, and a second tension biasing body F15.

The movement support member F13 includes first members F13a that support the forward movement pedal F1 via the pivot fulcrum portion F12, and an L-shaped second member F13b.

### Configuration of Forward Movement Torque Transmission Mechanism Provided in Forward Movement Mechanism of Movement Mechanism

The forward movement torque transmission mechanism F2 generates an assist force for moving the cart W forward, by transmitting a torque generated by the operation on the forward movement pedal F1 to the assist tire T and rotating the assist tire T.

The forward movement torque transmission mechanism F2 and the backward movement torque transmission mechanism B2 both transmit a torque for rotating the assist tire T in directions opposite to each other to the common assist tire T.

That is, the forward movement torque transmission mechanism F2 transmits, to the assist tire T, a torque that causes only one assist tire T provided in the cart movement assist device 100 to rotate in the R1 direction. The backward movement torque transmission mechanism B2 transmits, to the assist tire T, a torque that causes only one assist tire T provided in the cart movement assist device 100 to rotate in the R2 direction.

Similarly to the backward movement torque transmission mechanism B2, the forward movement torque transmission mechanism F2 includes the input-side chain guide F20, the output-side chain guide F21, and the annular chain F22. Unlike the backward movement torque transmission mechanism B2, the forward movement torque transmission mechanism F2 includes the auxiliary chain guide F23.

The auxiliary chain guide F23 is supported by the central shaft member C30 in a state of being rotatable around the central axis C3. The auxiliary chain guide F23 is disposed in front of the output-side chain guide F21. Accordingly, the output-side chain guide F21 is disposed between the front auxiliary chain guide F23 and the rear input-side chain guide F20 in the front-rear direction.

When viewed in the left-right direction, the input-side chain guide F20 and the auxiliary chain guide F23 are disposed inside the annular chain F22, and the output-side chain guide F21 is disposed outside the annular chain F22. The auxiliary chain guide F23 is provided to cause a rotation direction of the input-side chain guide F20 and a rotation direction of the output-side chain guide F21 to be opposite to each other.

### Operation of Backward Movement Mechanism

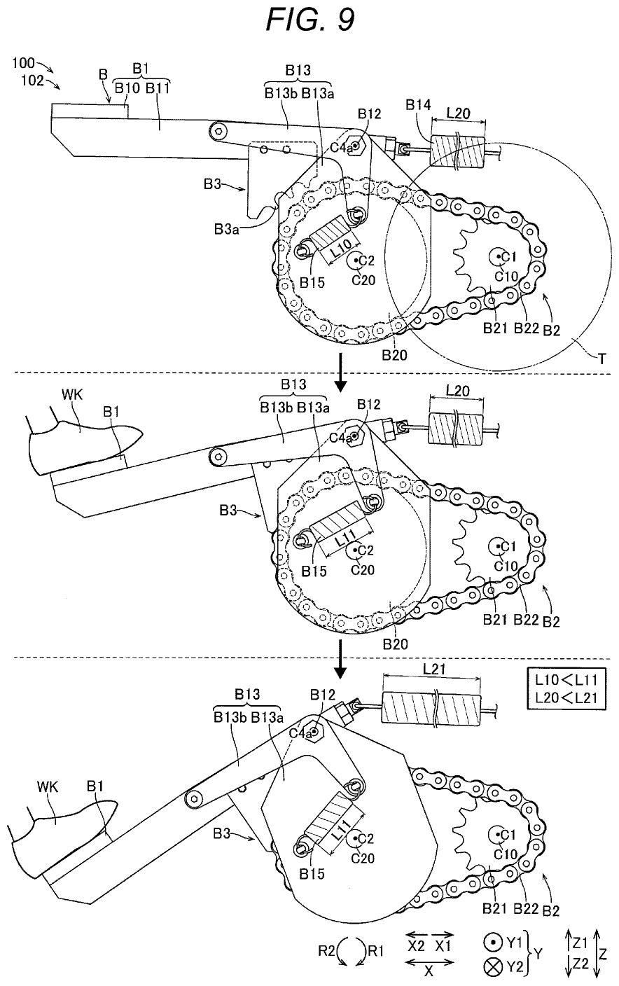

Next, an operation of the backward movement mechanism B of the cart movement assist device 100 will be described with reference to FIG. 9.

The worker WK starts the stepping-on operation on the backward movement pedal B1 of the cart movement assist device 100 attached to the stopped cart W. As a result, the backward movement pedal B1 pivots around the pivot fulcrum portion B12 (the central axis C4a). Specifically, the backward movement pedal B1 and the claw member B3 rotate in the R2 direction around the central axis C4a together with the L-shaped second member B13b against the biasing force (tension) of the second tension biasing body B15.

As a result, the second tension biasing body B15 extends from a length L10 to a length L11. The claw member B3 engages with the chain B22 part wound around the input-side chain guide B20.

Then, by further stepping the backward movement pedal B1 downward, the backward movement pedal B1 (pivot fulcrum portion B12) and the claw member B3 are moved in the R2 direction around the central axis C2 along the chain B22 by the movement support member B13 against the biasing force (tension) of the first tension biasing body B14 in a state in which the claw member B3 is engaged with the chain B22. That is, the chain B22 is rotated in the R2 direction.

As a result, the first tension biasing body B14 extends from a length L20 to a length L21. In addition, the torque in the R2 direction input on the input-side chain guide B20 side is transmitted to the output-side chain guide B21 via the chain B22, and the output-side chain guide B21 rotates in the R2 direction.

Then, the torque for rotating the output-side chain guide B21 in the R2 direction is transmitted to the assist tire T via the backward-movement one-way clutch T1 (see FIG. 5). Therefore, the assist tire T also rotates in the R2 direction, which is the same direction as that of the output-side chain guide B21, in accordance with the rotation of the output-side chain guide B21.

As a result, the stopped cart W starts to move backward. That is, the cart movement assist device 100 assists the initial movement of moving the cart W backward. In this way, since the cart W starts to move rearward by the stepping-on operation on the backward movement pedal B1, the burden on the worker WK to push and move the cart W rearward is reduced.

When the backward movement of the cart W is assisted, the torque in the R2 direction is transmitted from the assist tire T to the forward movement mechanism F via the forward-movement one-way clutch T2 (see FIG. 5), and the chain F22 of the forward movement mechanism F also rotates.

However, even if the chain F22 of the forward movement mechanism F rotates, the forward movement pedal F1 is not moved because the claw member F3 of the forward movement mechanism F does not engage with the chain F22. In short, the claw member F3 of the forward movement mechanism F cuts off the transmission of the torque from the backward movement pedal B1 subjected to the stepping-on operation to the forward movement pedal F1.

### Operation of Forward Movement Mechanism

Next, an operation of the forward movement mechanism F of the cart movement assist device 100 will be described with reference to FIG. 6.

The worker WK starts the stepping-on operation on the forward movement pedal F1 of the cart movement assist device 100 attached to the stopped cart W. As a result, the forward movement pedal F1 rotates around the pivot fulcrum portion F12 (the central axis C4b). Specifically, the L-shaped second member F13b, the forward movement pedal F1, and the claw member F3 pivot in the R2 direction around the central axis C4b against the biasing force (tension) of the second tension biasing body F15.

Then, the claw member F3 engages with the chain F22 part wound around the input-side chain guide F20.

Then, by further stepping on the forward movement pedal F1 downward, the forward movement pedal F1 (the pivot fulcrum portion F12) and the claw member F3 are moved by the movement support member F13 in the R2 direction around the central axis C2 along the chain F22 against the biasing force (tension) of the first tension biasing body F14 in a state in which the claw member F3 is engaged with the chain F22. That is, the chain F22 is rotated in the R2 direction.

As a result, the torque in the R2 direction input on the input-side chain guide F20 side is reversed by the auxiliary chain guide F23 and then transmitted to the output-side chain guide F21 via the chain F22, and the output-side chain guide F21 rotates in the R1 direction.

Then, the torque for rotating the output-side chain guide F21 in the R1 direction is transmitted to the assist tire T via the forward-movement one-way clutch T2. Therefore, the assist tire T also rotates in the R1 direction, which is the same direction as that of the output-side chain guide F21, in accordance with the rotation of the output-side chain guide F21.

As a result, the stopped cart W starts to move forward. That is, the cart movement assist device 100 assists the initial movement of moving the cart W forward. In this way, since the cart W starts to move forward by the stepping-on operation on the forward movement pedal F1, the burden on the worker WK to push and move the cart W forward is reduced.

When the forward movement of the cart W is assisted, the torque in the R1 direction is transmitted from the assist tire T to the backward movement mechanism B via the backward-movement one-way clutch T1, and the chain B22 of the backward movement mechanism B also rotates.

However, even if the chain B22 of the backward movement mechanism B rotates, the backward movement pedal B1 is not moved because the claw member B3 of the backward movement mechanism B does not engage with the chain B22 of the backward movement mechanism B. In short, the transmission of the torque from the forward movement pedal F1 subjected to the stepping-on operation to the backward movement pedal B1 is cut off by the claw member B3 of the backward movement mechanism B.

When the cart W is moved on the uneven ground G, the assist tire T may come into contact with the ground G and rotate even when the stepping-on operation on the backward movement pedal B1 and the forward movement pedal F1 is not performed. In this case, the chain B22 of the backward movement mechanism B and the chain F22 of the forward movement mechanism F also rotate, but the backward movement pedal B1 and the forward movement pedal F1 are not moved by the claw member B3 of the backward movement mechanism B in the non-engagement state and the claw member F3 of the forward movement mechanism F in the non-engagement state.

### Effects of First Embodiment

In the first embodiment, the following effects can be obtained.

In the first embodiment, as described above, the backward movement torque transmission mechanism B2 is provided which generates the assist force for moving the cart W backward, by transmitting the torque generated by the operation on the backward movement pedal B1 to the assist tire T and rotating the assist tire T. Accordingly, the backward movement torque transmission mechanism B2 can generate the assist force for moving the cart W backward, by transmitting the torque generated by the operation on the backward movement pedal B1 to the assist tire T and rotating the assist tire T. As a result, the cart movement assist device 100 can assist the backward movement of the cart W.

In the first embodiment, as described above, the backward movement torque transmission mechanism B2 increases the rotation amount of the assist tire T with respect to the rotation amount of the backward movement pedal B1 during operation and accelerates the rotation of the assist tire T with respect to the rotation of the backward movement pedal B1 by reducing the torque received from the backward movement pedal B1 and outputting the reduced torque from the assist tire T. Accordingly, the assist tire T can be rotated by converting the rotation amount (rotation speed) received from the backward movement pedal B1 into a larger rotation amount (rotation speed), by converting the torque received from the backward movement pedal B1 into a smaller torque and rotating the assist tire T. That is, the cart W can be relatively largely moved backward by the operation on the backward movement pedal B1.

In the first embodiment, as described above, the cart movement assist device 100 further includes the forward movement pedal F1 that is pivotably operated and the forward movement torque transmission mechanism F2 that generates the assist force for moving the cart W forward, by transmitting the torque generated by the operation on the forward movement pedal F1 to the assist tire T and rotating the assist tire T. The backward movement torque transmission mechanism B2 and the forward movement torque transmission mechanism F2 transmit, to the common assist tire T, torques for rotating the assist tire T in directions opposite to each other. Accordingly, the assist tire T for the backward movement and the assist tire T for the forward movement can be used in common, so that the device configuration can be simplified and the number of components can be reduced.

In the first embodiment, as described above, the cart movement assist device 100 further includes a connection switching member (the claw member B3) provided on the backward movement pedal B1 and switching between a connection state and a disconnection state of the backward movement pedal B1 and the backward movement torque transmission mechanism B2. The connection switching member (the claw member B3) connects the backward movement pedal B1 and the backward movement torque transmission mechanism B2 so that a torque is transmittable, when the backward movement pedal B1 is operated, and disconnects the backward movement pedal B1 and the backward movement torque transmission mechanism B2 when the backward movement pedal B1 is not operated. Accordingly, the backward movement pedal B1 and the backward movement torque transmission mechanism B2 can be disconnected when the backward movement pedal B1 is not operated, and thus the backward movement pedal B1 is prevented from being moved by transmitting the torque from the backward movement torque transmission mechanism B2 to the backward movement pedal B1 when the torque is transmitted from the forward movement torque transmission mechanism F2 to the backward movement torque transmission mechanism B2 via the assist tire T by operating the forward movement pedal F1.

In the first embodiment, as described above, the backward movement torque transmission mechanism B2 includes the input-side chain guide B20 that receives the torque from the backward movement pedal B1, the output-side chain guide B21 that is provided in the assist tire T and outputs the torque to the assist tire T, and the annular chain B22 wound around the input-side chain guide B20 and the output-side chain guide B21. The connection switching member includes the claw member B3 including a plurality of claw-shaped protruding portions B3a engaging with the chain B22 and configured to connect the backward movement pedal B1 and the chain B22 so that the torque is transmittable. Accordingly, the connection state and the disconnection state between the backward movement pedal B1 and the backward movement torque transmission mechanism B2 can be easily switched by switching between the engagement state and the non-engagement state of the claw member B3 having the plurality of protruding portions B3a with respect to the chain B22.

In the first embodiment, as described above, the backward movement pedal B1 is provided with the pivot fulcrum portion B12 that serves as the pivot fulcrum of the backward movement pedal B1 and causes the claw member B3 to engage with a part of the chain B22 wound around the input-side chain guide B20 by causing the claw member B3 and the backward movement pedal B1 to pivot, and the movement support member B13 that supports the backward movement pedal B1 via the pivot fulcrum portion B12 and causes the claw member B3 in a state of being engaged with the chain B22 to move along a circumferential direction of the input-side chain guide B20 by the pivot fulcrum portion B12. Accordingly, when the backward movement pedal B1 is operated, the movement support member B13 can cause the claw member B3 and the chain B22 to move along the circumferential direction of the input-side chain guide B20 in a state in which the claw member B3 is engaged with the part of the chain B22 wound around the input-side chain guide B20 by the pivot fulcrum portion B12. Accordingly, when the backward movement pedal B1 is operated, the engagement state between the claw member B3 provided on the backward movement pedal B1 and the chain B22 can be maintained for a relatively long period of time. As a result, the torque can be effectively transmitted from the backward movement pedal B1 to the assist tire T.

### Second Embodiment

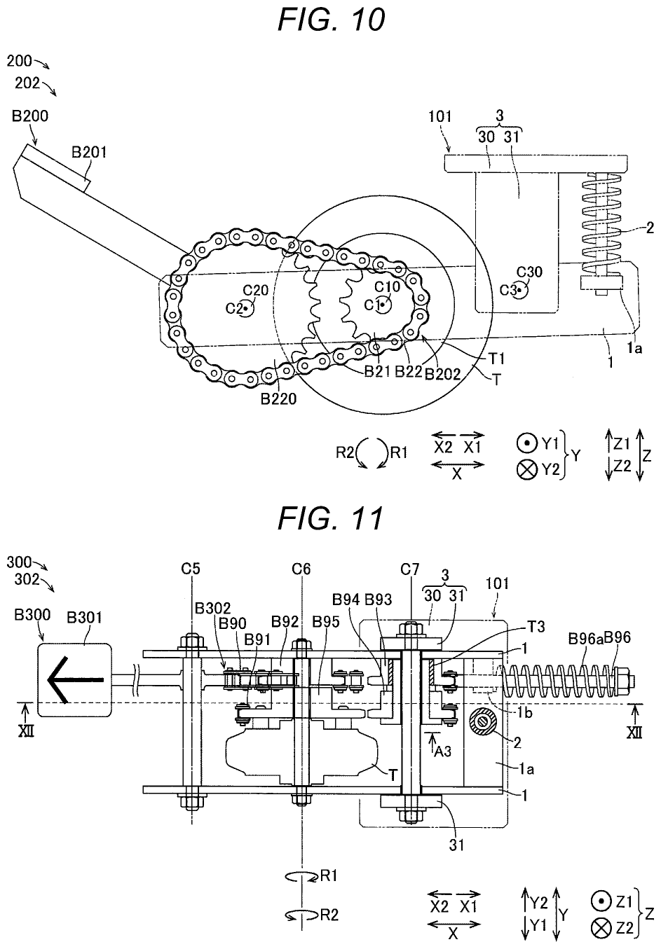

Next, a cart movement assist device 200 according to a second embodiment will be described with reference to FIG. 10. Unlike the first embodiment in which the cart movement assist device 100 includes both the backward movement mechanism B and the forward movement mechanism F, the second embodiment describes an example in which the cart movement assist device 200 includes a backward movement mechanism B200 and does not include a forward movement mechanism. The same parts as those in the first embodiment are denoted by the same reference signs, and the description thereof is omitted.

The cart movement assist device 200 includes the attachment mechanism 101 and a movement mechanism 202 that is driven to move the cart W (see FIG. 1).

The movement mechanism 202 includes the assist tire T and the backward movement mechanism B200 that rotates the assist tire T in the R2 direction.

The backward movement mechanism B200 includes a backward movement pedal B201 and a backward movement torque transmission mechanism B202. The cart movement assist device 200 is not provided with a claw member as in the cart movement assist device 100 according to the first embodiment.

The backward movement torque transmission mechanism B202 includes an input-side chain guide B220, the output-side chain guide B21, and the annular chain B22. As an example, the input-side chain guide B220 is implemented by a sprocket that guides the wound chain B22. The backward movement pedal B201 is fixed to the input-side chain guide B220. Accordingly, the backward movement pedal B201 rotates in the R2 direction together with the input-side chain guide B220.

The backward movement pedal B201 is constantly biased (pulled) forward by a biasing body (not shown). That is, the backward movement pedal B201 constantly receives a torque in the R1 direction about the central axis C2.

The backward movement torque transmission mechanism B202 generates an assist force for moving the cart W backward, by transmitting the torque generated by the operation on the backward movement pedal B201 to the assist tire T and rotating the assist tire T.

Other configurations of the second embodiment are the same as those of the first embodiment.

### Effects of Second Embodiment

In the second embodiment, the following effects can be obtained.

In the second embodiment, similarly to the first embodiment, the backward movement torque transmission mechanism B202 is provided which generates the assist force for moving the cart W backward, by transmitting the torque generated by the operation on the backward movement pedal B201 to the assist tire T and rotating the assist tire T. Accordingly, the backward movement torque transmission mechanism B202 can generate the assist force for moving the cart W backward, by transmitting the torque generated by the operation on the backward movement pedal B201 to the assist tire T and rotating the assist tire T. As a result, the cart movement assist device 200 can assist the backward movement of the cart W.

Other effects of the second embodiment are the same as those of the first embodiment.

### Modification

The embodiments disclosed herein should be considered to be illustrative and not restrictive in all respects. The scope of this disclosure is indicated not by the description of the above embodiment but by the claims, and all changes (modifications) within the meaning and scope equivalent to the claims are included.

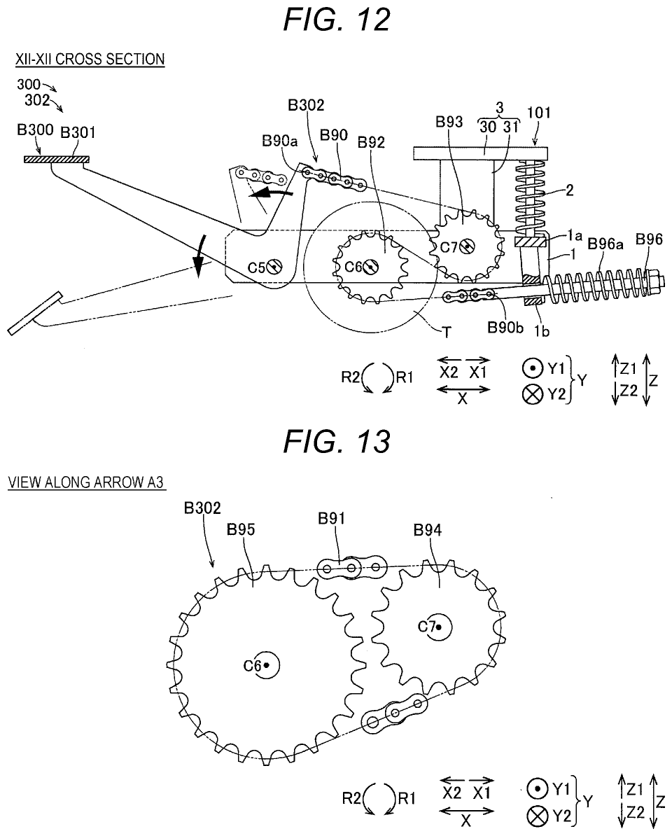

For example, in the first and second embodiments, an example in which the backward movement torque transmission mechanism of the backward movement mechanism includes only one annular chain has been described. In this disclosure, for example, as in a cart movement assist device 300 according to a modification shown in FIGS. 11 to 13, a backward movement torque transmission mechanism B302 of a backward movement mechanism B300 may include one non-annular chain B90 and one annular chain B91. In the present modification, the same parts as those in the first embodiment are denoted by the same reference signs, and description thereof is omitted.

Specifically, the cart movement assist device 300 includes the attachment mechanism 101 and a movement mechanism 302 that is driven to move the cart W (see FIG. 1).

The movement mechanism 302 includes the assist tire T and the backward movement mechanism B300 that rotates the assist tire T in the R2 direction. The backward movement mechanism B300 includes a backward movement pedal B301 and the backward movement torque transmission mechanism B302.

The backward movement pedal B301 is supported by the support members 1 of the attachment mechanism 101 in a state of being pivotable around a central axis C5. The backward movement pedal B301 is formed in an L shape, and has a front end portion to which one end B90a of the non-annular chain B90 is fixed.

The backward movement torque transmission mechanism B302 includes the non-annular chain B90, the annular chain B91, a first sprocket B92 and a second sprocket B93 around which the non-annular chain B90 is wound, and a third sprocket B94 and a fourth sprocket B95 around which the annular chain B90 is wound. The non-annular chain B90 and the annular chain B91 are arranged side by side in the left-right direction. The first sprocket B92 and the second sprocket B93 normally rotate in the directions opposite to each other by the non-annular chain B90. The third sprocket B94 and the fourth sprocket B95 normally rotate in the same direction by the annular chain B91. The backward movement torque transmission mechanism B302 includes a shaft member B96 to which the other end B90b of the non-annular chain B90 is fixed.

The first sprocket B92, the fourth sprocket B95, and the assist tire T rotate around a central axis C6. The torque is not transmitted between the first sprocket B92 and the fourth sprocket B95, and the first sprocket B92 and the fourth sprocket B95 normally rotate in directions opposite to each other.

The second sprocket B93 and the third sprocket B94 rotate around a central axis C7. The assist tire T is fixed to the fourth sprocket B95, and the fourth sprocket B95 rotates together with the assist tire T.

The non-annular chain B90 is wound around the first sprocket B92 and the second sprocket B93 in an S-shape. The non-annular chain B90 pivots in the R1 direction around the central axis C6 of the first sprocket B92 when pulled forward by the backward movement pedal B301. At this time, the second sprocket B93 rotates in the R2 direction around the central axis C7.

The shaft member B96 is provided with a compression biasing body B96a formed of a compression coil spring. The support member 1 is provided with an abutting member 1b which has a through hole through which the shaft member B96 is inserted and which abuts against a rear end portion of the compression biasing body B96a. The compression biasing body B96a constantly biases the backward movement pedal B301 via the non-annular chain B90 so that a torque in the R1 direction around the central axis C5 acts on the backward movement pedal B301. Accordingly, when the stepping-on operation on the backward movement pedal B301 is released, the backward movement pedal B301 pivots in the R1 direction by the biasing force of the compression biasing body B96a and returns to a predetermined initial position.

A one-way clutch T3 is provided between the second sprocket B93 and the third sprocket B94. The one-way clutch T3 transmits a torque to the third sprocket B94 only when the stepping-on operation on the backward movement pedal B301 is performed to rotate the second sprocket B93 in the R2 direction. When the third sprocket B94 rotates in the R2 direction, the assist tire T and the fourth sprocket B95 rotate in the R2 direction via the annular chain B91. As a result, the stopped cart W starts to move backward. Note that this disclosure is not limited to the above-described modification, and the backward movement torque transmission mechanism of the backward movement mechanism may include three or more chains.

In the first and second embodiments, an example in which the backward movement torque transmission mechanism of the backward movement mechanism includes the chain and the sprocket has been described, but this disclosure is not limited thereto. In this disclosure, the backward movement torque transmission mechanism of the backward movement mechanism and the forward movement torque transmission mechanism of the forward movement mechanism may include a belt and a pulley instead of the chain and the sprocket.

In the first embodiment, an example in which the forward movement torque transmission mechanism includes the chain and the sprocket has been described, but this disclosure is not limited thereto. In this disclosure, the forward movement torque transmission mechanism of the forward movement mechanism may include a belt and a pulley instead of the chain and the sprocket.

In the first embodiment, an example in which the input-side chain guide of the forward movement torque transmission mechanism (backward movement torque transmission mechanism) is implemented by the circular guide member that guides the wound chain by sliding has been described, but this disclosure is not limited thereto. In this disclosure, the input-side chain guide of the forward movement torque transmission mechanism (backward movement torque transmission mechanism) may be implemented by a sprocket or the like.

In the first embodiment, an example in which the connection switching member disclosed here that switches between the connection state and the disconnection state of the backward movement pedal and the backward movement torque transmission mechanism is implemented by the claw member having the protruding portions has been described, but this disclosure is not limited thereto. In this disclosure, the connection switching member may be implemented by a member that switches between the connection state and the disconnection state of the backward movement pedal and the backward movement torque transmission mechanism by other methods such as a frictional force.

In the first embodiment, an example in which a common assist tire is provided for the backward movement torque transmission mechanism and the forward movement torque transmission mechanism has been described, but this disclosure is not limited thereto. In this disclosure, one dedicated assist tire may be provided for each of the backward movement torque transmission mechanism and the forward movement torque transmission mechanism.

In the first embodiment, an example in which the backward movement mechanism is disposed on the left of the assist tire and the forward movement mechanism is disposed on the right of the assist tire has been described, but this disclosure is not limited thereto. In this disclosure, the backward movement mechanism may be disposed on the right of the assist tire, and the forward movement mechanism may be disposed on the left of the assist tire.

According to an aspect of this disclosure, a cart movement assist device, which is attached to a rear end portion side of a cart which is a side where a worker is located, and which assists a movement of the cart, includes: an assist tire; a backward movement pedal that is pivotably operated; and a backward movement torque transmission mechanism configured to generate an assist force for moving the cart backward, by transmitting a torque generated by an operation on the backward movement pedal to the assist tire and rotating the assist tire.

As described above, the cart movement assist device according to the above aspect of this disclosure is provided with the backward movement torque transmission mechanism that generates the assist force for moving the cart backward, by transmitting the torque generated by the operation on the backward movement pedal to the assist tire and rotating the assist tire. Accordingly, the backward movement torque transmission mechanism can generate the assist force for moving the cart backward, by transmitting the torque generated by the operation on the backward movement pedal to the assist tire and rotating the assist tire. As a result, the cart movement assist device can assist the backward movement of the cart.

In the cart movement assist device according to the above aspect, the backward movement torque transmission mechanism may increase a rotation amount of the assist tire with respect to a rotation amount of the backward movement pedal during operation and accelerate rotation of the assist tire with respect to rotation of the backward movement pedal by reducing the torque received from the backward movement pedal and outputting the reduced torque from the assist tire.

With this configuration, the assist tire can be rotated by converting the rotation amount (rotation speed) received from the backward movement pedal into a larger rotation amount (rotation speed), by converting the torque received from the backward movement pedal into a smaller torque and rotating the assist tire. That is, the cart can be relatively largely moved backward by the operation on the backward movement pedal.

The cart movement assist device according to the above aspect may further include: a forward movement pedal that is pivotably operated; and a forward movement torque transmission mechanism configured to generate an assist force for moving the cart forward, by transmitting a torque generated by an operation on the forward movement pedal to the assist tire and rotating the assist tire. The backward movement torque transmission mechanism and the forward movement torque transmission mechanism transmit, to the common assist tire, torques for rotating the assist tire in directions opposite to each other.

With this configuration, the assist tire for the backward movement and the assist tire for the forward movement can be used in common, so that the device configuration can be simplified and the number of components can be reduced.

In this case, the cart movement assist device may further include a connection switching member provided on the backward movement pedal and configured to switch between a connection state and a disconnection state of the backward movement pedal and the backward movement torque transmission mechanism. The connection switching member connects the backward movement pedal and the backward movement torque transmission mechanism so that a torque is transmittable, when the backward movement pedal is operated, and disconnects the backward movement pedal and the backward movement torque transmission mechanism when the backward movement pedal is not operated.

With this configuration, the backward movement pedal and the backward movement torque transmission mechanism can be disconnected when the backward movement pedal is not operated, and thus the backward movement pedal is prevented from being moved by transmitting the torque from the backward movement torque transmission mechanism to the backward movement pedal when the torque is transmitted from the forward movement torque transmission mechanism to the backward movement torque transmission mechanism via the assist tire by operating the forward movement pedal.

In the configuration including the connection switching member, the backward movement torque transmission mechanism may include a circular input-side chain guide configured to receive the torque from the backward movement pedal, a circular output-side chain guide provided in the assist tire and configured to output the torque to the assist tire, and an annular chain wound around the input-side chain guide and the output-side chain guide, and the connection switching member includes a claw member including a plurality of claw-shaped protruding portions engaging with the chain and configured to connect the backward movement pedal and the chain so that the torque is transmittable.

With this configuration, the connection state and the disconnection state between the backward movement pedal and the backward movement torque transmission mechanism can be easily switched by switching between the engagement state and the non-engagement state of the claw member having the plurality of protruding portions with respect to the chain.

In the configuration in which the connection switching member includes the claw member, the backward movement pedal may be provided with a pivot fulcrum portion serving as a pivot fulcrum of the backward movement pedal and configured to cause the claw member to engage with a part of the chain wound around the input-side chain guide by causing the claw member and the backward movement pedal to pivot, and a movement support member configured to support the backward movement pedal via the pivot fulcrum portion and cause the claw member in a state of being engaged with the chain to move along a circumferential direction of the input-side chain guide by the pivot fulcrum portion.

With this configuration, when the backward movement pedal is operated, the movement support member can cause the claw member and the chain to move along the circumferential direction of the input-side chain guide in a state in which the claw member is engaged with the part of the chain wound around the input-side chain guide by the pivot fulcrum portion. Accordingly, when the backward movement pedal is operated, the engagement state between the claw member provided on the backward movement pedal and the chain can be maintained for a relatively long period of time. As a result, the torque can be effectively transmitted from the backward movement pedal to the assist tire.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A cart movement assist device that is attached to a rear end portion side of a cart which is a side where a worker is located, and that assists a movement of the cart, the cart movement assist device comprising:
an assist tire;
a backward movement pedal that is pivotably operated; and
a backward movement torque transmission mechanism configured to generate an assist force for moving the cart backward, by transmitting a torque generated by an operation on the backward movement pedal to the assist tire and rotating the assist tire.

2. The cart movement assist device according to claim 1, wherein
the backward movement torque transmission mechanism increases a rotation amount of the assist tire with respect to a rotation amount of the backward movement pedal during operation and accelerates rotation of the assist tire with respect to rotation of the backward movement pedal by reducing the torque received from the backward movement pedal and outputting the reduced torque from the assist tire.

3. The cart movement assist device according to claim 1, further comprising:
a forward movement pedal that is pivotably operated; and
a forward movement torque transmission mechanism configured to generate an assist force for moving the cart forward, by transmitting a torque generated by an operation on the forward movement pedal to the assist tire and rotating the assist tire, wherein
the backward movement torque transmission mechanism and the forward movement torque transmission mechanism transmit, to the common assist tire, torques for rotating the assist tire in directions opposite to each other.

4. The cart movement assist device according to claim 3, further comprising:
a connection switching member provided on the backward movement pedal and configured to switch between a connection state and a disconnection state of the backward movement pedal and the backward movement torque transmission mechanism, wherein
the connection switching member
connects the backward movement pedal and the backward movement torque transmission mechanism so that a torque is transmittable, when the backward movement pedal is operated, and
disconnects the backward movement pedal and the backward movement torque transmission mechanism when the backward movement pedal is not operated.

5. The cart movement assist device according to claim 4, wherein
the backward movement torque transmission mechanism includes
a circular input-side chain guide configured to receive the torque from the backward movement pedal,
a circular output-side chain guide provided in the assist tire and configured to output the torque to the assist tire, and
an annular chain wound around the input-side chain guide and the output-side chain guide, and
the connection switching member includes a claw member including a plurality of claw-shaped protruding portions engaging with the chain and configured to connect the backward movement pedal and the chain so that the torque is transmittable.

6. The cart movement assist device according to claim 5, wherein
the backward movement pedal is provided with
a pivot fulcrum portion serving as a pivot fulcrum of the backward movement pedal and configured to cause the claw member to engage with a part of the chain wound around the input-side chain guide by causing the claw member and the backward movement pedal to pivot, and
a movement support member configured to support the backward movement pedal via the pivot fulcrum portion and cause the claw member in a state of being engaged with the chain to move along a circumferential direction of the input-side chain guide by the pivot fulcrum portion.
